(19) United States
(12) Patent Application Publication
(10) Pub. No.: US 2005/0128507 A1
(43) Pub. Date: Jun. 16, 2005

(54) Image forming apparatus and information communicating method

(75) Inventor: Takaharu Ouchi, Tagata-gun (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/731,102

(22) Filed: Dec. 10, 2003

(51) Int. Cl. G06F 15/00

(52) U.S. Cl. 358/1.15; 358/448

(57) ABSTRACT

In case abnormality in a network is detected, a CPU of a digital multi-functional peripheral sends, when facsimile connection to a management center via a telephone line has been detected, intra-apparatus information relating the digital multi-functional peripheral to the management center via the facsimile connection. Alternatively, when connection to a personal computer has been detected, the CPU of the digital multi-functional peripheral sends the intra-apparatus information to the management center via the personal computer.

### BACKGROUND OF THE INVENTION

The present invention relates to an image forming apparatus, such as a digital multi-functional peripheral, and an information communicating method, which can transmit/receive information with a management center via a network.

There is known a modern digital multi-functional peripheral (with functions of a copying machine, a facsimile and a printer), which has such a function that the digital multi-functional peripheral is connected to a management center via a network and information relating to the inside of the apparatus is managed by the management center in a centralized manner.

In an information communication system comprising the digital multi-functional peripheral and the management center, a self-diagnosis task is executed in parallel with normal tasks of the digital multi-functional peripheral (or is executed between the normal tasks). For example, a value of a toner sensor is read to detect the amount of residual toner, or line breakage of a lamp or a sensor is detected, or the amount of residual paper is detected by a paper feed sensor. The detection information is temporarily stored in a hard disk drive or a memory. The detection information (intra-apparatus information) is sent to the management center (server) via a network. In this case, the communication means is e-mail, FTP, HTTP, etc.

The server in the management center manages the intra-apparatus information in a centralized manner, which has been sent from each digital multi-functional peripheral. Based on the information, specifically selected services can be provided to clients.

However, when abnormality occurs in the network communication (e.g. a fault of the network I/F section in the digital multi-functional peripheral, or a fault in the network itself), the digital multi-functional peripheral is unable to send intra-apparatus information to the management center. This results in such a problem that the management center is unable to manage the digital multi-functional peripheral, whose intra-apparatus information cannot be received.

### BRIEF SUMMARY OF THE INVENTION

The object of an aspect of the present invention is to provide an image forming apparatus and an information communicating method, which can continue transmission of intra-apparatus information by communication with a management center, even if abnormality occurs in a network communication.

According to an aspect of the present invention, there is provided an image forming apparatus capable of performing transmission/reception of information with a management center via communication means, comprising: a first control section that detects communication means, which is different from the communication means, when abnormality occurs in the transmission/reception of information with the management center; and a second control section that controls the transmission/reception of information with the management center by using the communication means detected by the first control section.

According to another aspect of the present invention, there is provided an information communicating method for an image forming apparatus capable of performing transmission/reception of information with a management center via communication means, comprising: detecting communication means, which is different from the communication means, when abnormality occurs in the transmission/reception of information with the management center; and controlling the transmission/reception of information with the management center by using the detected communication means.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 schematically shows the structure of a digital multi-functional peripheral according to an image forming apparatus of the present invention;

FIG. 2 is a block diagram showing a connection mode of an ordinary management system in a case where a digital multi-functional peripheral is used;

FIG. 3 is a flow chart for explaining an operation in a digital multi-functional peripheral at a time of network abnormality detection;

FIG. 4 shows a state in which a digital multi-functional peripheral has become connectable to a management center via a telephone line; and

FIG. 5 shows a state in which a digital multi-functional peripheral has become connectable to a management center via a personal computer.

### DETAILED DESCRIPTION OF THE INVENTION

An embodiment of the present invention will now described with reference to the accompanying drawings.

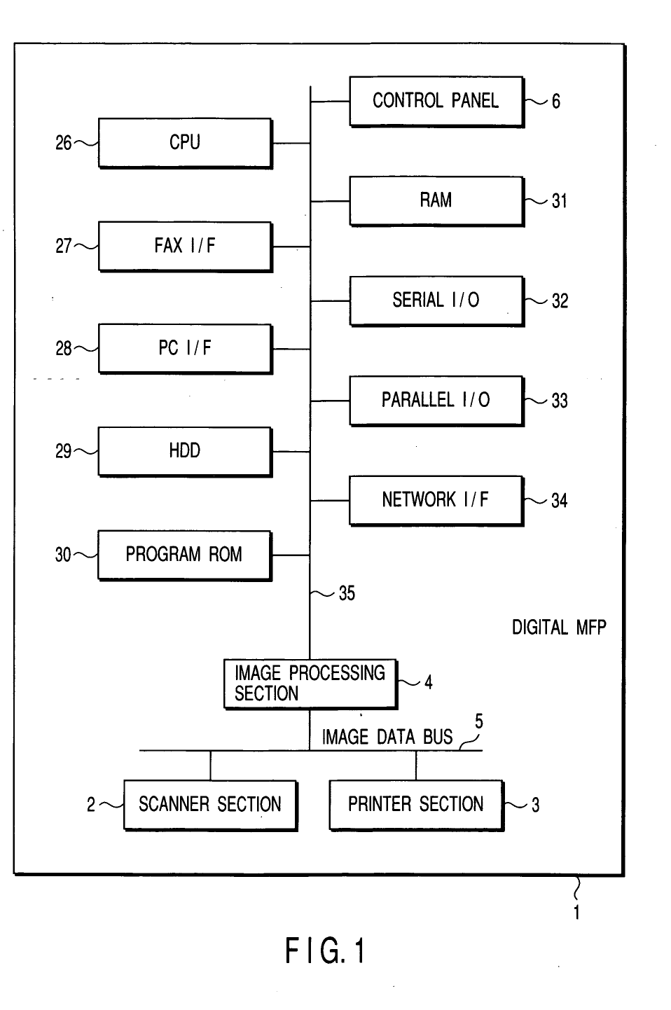

FIG. 1 schematically shows the structure of a digital multi-functional peripheral (MFP) according to an image forming apparatus of the present invention. The control system of the digital MFP 1 comprises a CPU 26, a FAX interface (I/F) 27, a PC interface (I/F) 28, an HDD 29, a program ROM 30, a RAM 31, a serial I/O 32, a parallel I/O 33, a network interface (I/F) 34 and a bus 35.

The CPU 26 is a microprocessor that controls the entirety of the digital MFP 1.

The FAX I/F 27 is an interface that executes a facsimile control.

The PC I/F 28 is an interface with a personal computer that is to be described later.

The HDD 29 is a hard disk drive that stores image data.

The program ROM 30 stores a control program.

The RAM 31 is a working RAM that is to be used by the control program.

The network I/F 34 is an interface that executes a network control.

The bus 35 is connected to devices such as the CPU 26, FAX I/F 27, PC I/F 28, HDD 29, program ROM 30, RAM 31, serial I/O 32, parallel I/O 33 and network I/F 34.

A control panel 6 having a liquid crystal display section is connected to the CPU 26 via the bus 35. The liquid crystal display section of the control panel 6 displays various information, and executes an input operation through a touch panel (not shown).

An image processing section 4 is connected to the CPU 26 via the bus 35. A scanner section 2 and a printer section 3 are connected to the image processing section 4 via an image data bus 5.

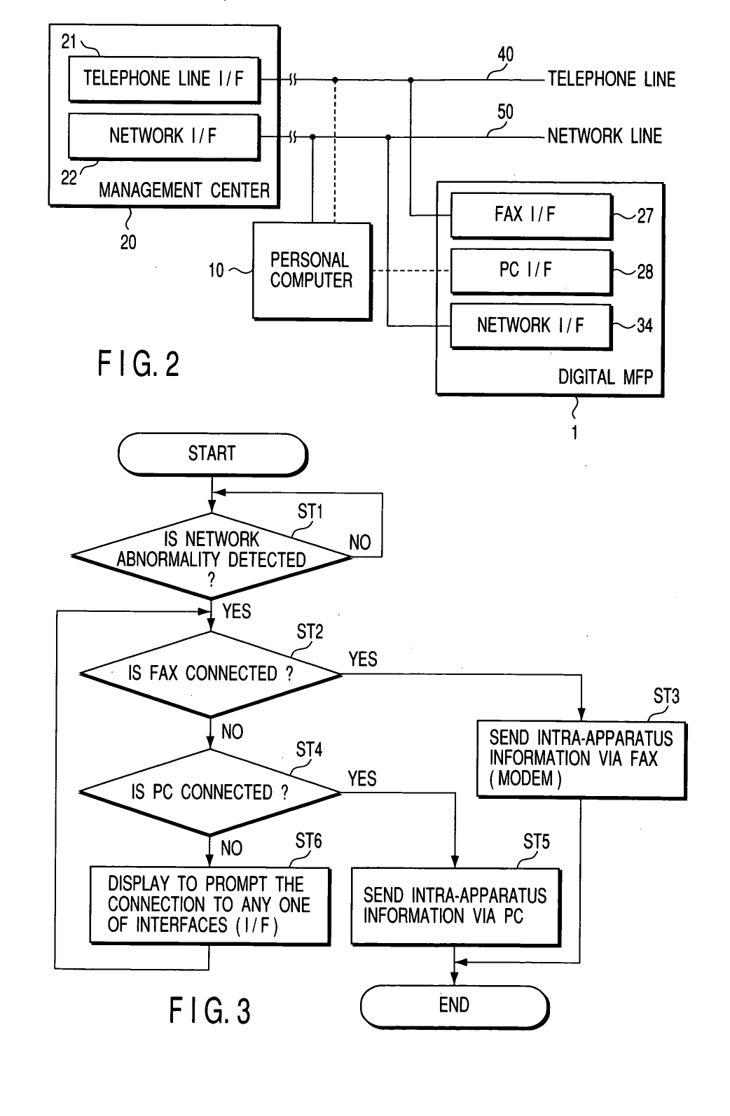

FIG. 2 illustrates a connection mode of an ordinary management system in a case where the digital MFP 1 is used.

As is shown in the Figure, the network I/F 34 of the digital MFP 1 is connected to a network line 50, and the FAX I/F 27 is connected to a telephone line 40. In the Figure, the digital MFP 1 and network line 50 are connected by wire, but wireless connection is available.

The digital MFP 1 is connectable to a personal computer (PC) 10 via the PC I/F 28. The PC 10 is connected to the network line 50 and is connectable to the telephone line 40.

The digital MFP 1 is connected to a management center 20 via the telephone line 40 and network line 50.

The management center 20 is connected to the telephone line 40 via a telephone line interface (I/F) 21, and also connected to the network line 50 via a network interface (I/F) 22. The management center 20 may be configured as a personal computer.

If the PC 10 is equipped with a network interface, the PC 10 is connected to the network in the normal state, and it executes a print-out operation, etc. via the network. If the PC 10 is not equipped with a network interface, the PC 10 is connected to the digital MFP 1 via an interface such as a parallel interface, USB or Bluetooth. Depending on cases, the PC 10 may be connected to the telephone line via a modem.

In this example, the PC 10 is connected to the telephone line 40 and network line 50. The PC 10 is able to communicate via the network line 50 with the management center 20 that manages the digital MFP 1 in a centralized manner. The PC 10 is also able to communicate with the management center 20 via the telephone line 40.

With the above structure, the digital MFP 1 performs an ordinary task and a self-diagnosis task on the basis of the control program prestored in the program ROM 30. The digital MFP 1 of the present invention is required to detect a network abnormality during execution of the self-diagnosis task.

A method of detecting a network abnormality is described.

Network abnormality is generally classified into two categories: an abnormality in the network I/F section within the digital MFP, and an abnormality in the network itself (infrastructure).

As regards the abnormality in the network I/F section within the digital MFP, it can be detected by issuing a ping command to the MFP (or means other than the ping command may be used if such means can send data to the MFP without intervention of the network). If the MFP can respond, this confirms the normal operation of the network I/F section. If not, this reveals some abnormality in the network I/F section.

As regards the abnormality in the network itself, it can be detected by occurrence of, e.g. a time-out error, when intra-apparatus information is sent to the server of the management center. In the present invention, when network abnormality is detected, a substitute communication means is used for communication with the management center.

Referring to a flow chart of FIG. 3, a description will now be given of the operation of the digital MFP 1 with the above structure in a case where a network abnormality is detected. In this example, the order of priority of substitute communication means is set in the order of the facsimile and the personal computer. This order may be altered by setting.

When abnormality of the network is detected (ST1), the CPU 26 of digital MFP 1 makes an attempt to detect facsimile connection to the management center 20 via the FAX I/F 27 and telephone line 40 (ST2).

If the facsimile connection is established (ST2), the CPU 26 converts the related intra-apparatus information to a two-dimensional bar code and sends it as a facsimile image to the management center 20 (ST3). Thus, the process ends.

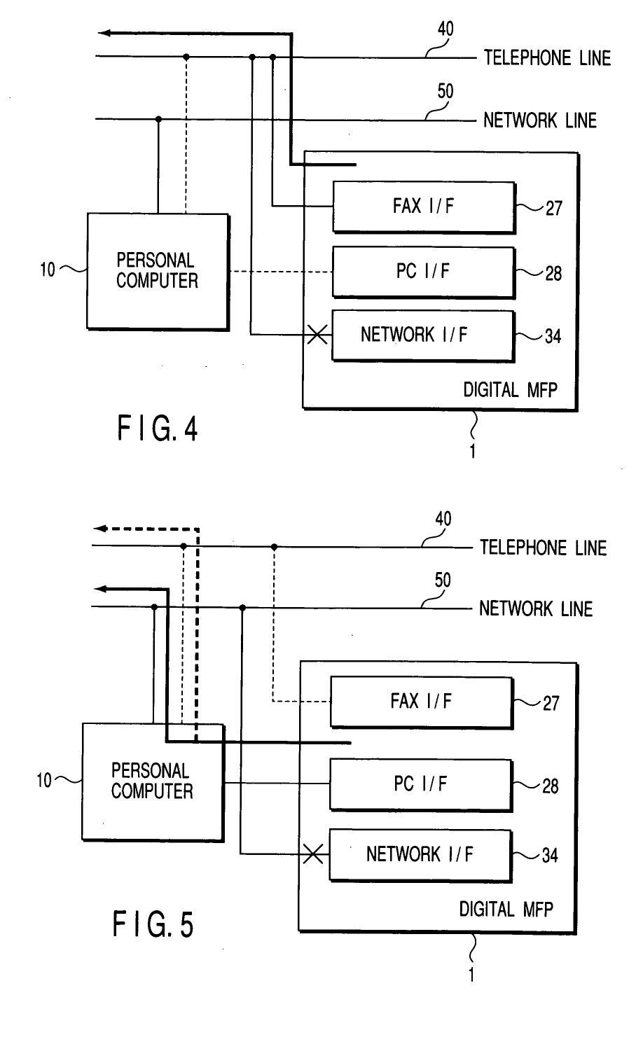

FIG. 4 shows a state in which the digital MFP 1 has become connectable to the management center 20 via the FAX I/F 27 and telephone line 40.

In the management center 20, the facsimile image that has been sent is read by a bar code reader (not shown). A facsimile image that is to be sent may be character information. In this case, however, time-consuming manual input of information is required. Alternatively, the FAX I/F 27 may be used as a modem for dial-up connection, and direct data transmission/reception may be performed with a dial-up server that is provided in the management center 20.

If facsimile connection fails to be detected in step ST2, the CPU 26 makes an attempt to detect connection with the PC 10 via the PC I/F 28 (ST4). The mode of connection to the PC 10 may be parallel connection, USB, Bluetooth, etc.

Assume that the PC 10 is connected to the network line 50 or the telephone line (via modem) 40. In addition, assume that utility software is pre-installed in the PC 10 and information on the server of the management center 20 is set as information on the destination of connection.

When connection to the PC 10 is detected, the CPU 26 sends the related intra-apparatus information to the PC 10 via the PC I/F 28. Using the utility software, the PC 10 sends the received intra-apparatus information to the management center 20 via the network line 50 or telephone line 40 (ST5). Thus, the process ends.

FIG. 5 shows a state in which the digital MFP 1 has become connectable to the management center 20 via the PC 10.

If connection to the PC 10 fails to be detected in step ST4, the CPU 26 instructs the control panel 6 to display content as to whether connection to the facsimile or PC 10 should be established or communication with a service center should be made (ST6). Then, the control returns to step ST2. In the present embodiment, the intra-apparatus information that relates to the inside of the multi-functional peripheral has been described as content of communication. However, the content of communication is not limited to the intra-apparatus information.

In this embodiment, the normal means for communication with the management server has been described as the network. Alternatively, the normal means for communication with the management server may be communication with the modem or communication via the personal computer. If these communication means have become unavailable, other communication means may be adopted.

As has been described above, according to the embodiment of the present invention, when network communication by the digital MFP has become unavailable, substitute communication means (communication via facsimile or personal computer) may be used and thus intra-apparatus information (or other information) can be sent to (received by) the management center.

The substitute communication means employed in the above-described embodiment is generally used by the digital MFP, and this can reduce the cost necessary for realizing the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image forming apparatus capable of performing transmission/reception of information with a management center via communication means, comprising:
a first control section that detects communication means, which is different from said communication means, when abnormality occurs in the transmission/reception of information with the management center; and
a second control section that controls the transmission/reception of information with the management center by using the communication means detected by the first control section.

2. The image forming apparatus according to claim 1, wherein said communication means is communication means using a network line, communication means using a telephone line or communication means using a personal computer.

3. The image forming apparatus according to claim 1, wherein the first control section detects communication means using a telephone line.

4. The image forming apparatus according to claim 1, wherein the first control section detects communication means using a personal computer.

5. The image forming apparatus according to claim 4, wherein the communication means using the personal computer connects to the management center via a network, or connects to the management center via a telephone line using a modem.

6. The image forming apparatus according to claim 1, wherein when the first control means detects the communication means using a telephone line, the second control section converts the information to a two-dimensional bar code, and sends the two-dimensional bar code as a facsimile image to the management center.

7. The image forming apparatus according to claim 1, wherein when the communication means using a personal computer is detected, the second control section controls the transmission/reception of information with the management center via the personal computer.

8. The image forming apparatus according to claim 1, wherein when the first control means fails to detect the communication means, the second control section controls guidance display relating to connection to any one of the communication means or relating to communication with a service center.

9. An image forming apparatus capable of performing transmission/reception of information with a management center via a network, comprising:
first detection means for detecting whether the transmission/reception of information with the management center is executable using a telephone line, when abnormality occurs in the transmission/reception of information with the management center;
first control means for controlling the transmission/reception of information with the management center using the telephone line, when the first detection means detects that the transmission/reception of information with the management center is executable using the telephone line;
second detection means for detecting whether the transmission/reception of information with a pre-provided personal computer, which is connected to the network or the telephone line, is executable, when the first detection means detects that the transmission/reception of information with the management center is not executable using the telephone line; and
second control means for controlling the transmission/reception of information with the management center via the network or telephone line using the personal computer, when the second detection means detects that the transmission/reception of information with the personal computer is executable.

10. An information communicating method for an image forming apparatus capable of performing transmission/reception of information with a management center via communication means, comprising:
detecting communication means, which is different from said communication means, when abnormality occurs in the transmission/reception of information with the management center; and
controlling the transmission/reception of information with the management center by using the detected communication means.
